(19) United States
(12) Patent Application Publication
(10) Pub. No.: US 2025/0046492 A1
(43) Pub. Date: Feb. 6, 2025

(54) CABLE

(71) Applicants: Fuyu Electronic Technology (Huai’an) Co., Ltd., Huai’an (CN); FOXCONN INTERCONNECT TECHNOLOGY LIMITED, Grand Cayman (KY)

(72) Inventors: WEI XING, Huaian (CN); A-NAN YANG, Huaian (CN); XIAO-FEI LIU, Huaian (CN); HAN-RUN XIE, Huaian (CN); LU-YU CHANG, New Taipei (TW)

(21) Appl. No.: 18/792,031

(22) Filed: Aug. 1, 2024

(30) Foreign Application Priority Data
Aug. 3, 2023 (CN) 202322089641.6

(51) Int. Cl. H01B 7/18; H01B 11/00; H01B 11/10; H01B 11/18; H01B 11/20

(52) U.S. Cl. CPC H01B 7/1855; H01B 11/002; H01B 11/1091; H01B 11/1843; H01B 11/203

(57) ABSTRACT

A cable includes: a core wire; a sheath covering the core wire; a shielding layer covering the sheath; and an outer insulating layer covering the shielding layer; wherein the core wire includes a pair of inner core wires and an insulating layer covering the pair of inner core wires by extrusion molding, each of the pair of inner core wires includes an inner conductor and an inner insulating layer covering the inner conductor, and the sheath wraps the insulating layer in a spiral winding way.

### BACKGROUND OF THE INVENTION

### Field of the Invention

The present invention relates generally to a cable, and more particularly to a cable used to transmit high frequency signals.

### Description of Related Arts

U.S. Patent Application Publication No. 2022/0215987 discloses a cable comprising a core wire, a first shielding layer covering the core wire, a second shielding layer covering the first shielding layer, and an outer layer covering the second shielding layer. The core wire includes two inner conductors, a respective insulating layer covering each of the two inner conductors by extrusion molding, and a sheath layer covering the insulating layer by extrusion molding. The insulating layer and the sheath layer outside the inner conductors of the core wire are all extruded, making the cable not easy to bend.

Therefore, it is necessary to provide a new cable with reliable signal transmission and easy to bend.

### SUMMARY OF THE INVENTION

A main object of the present invention is to provide a cable with good electrical properties and easy bending.

To achieve the above object, a cable includes: a core wire; a sheath covering the core wire; a shielding layer covering the sheath; and an outer insulating layer covering the shielding layer; wherein the core wire includes a pair of inner core wires and an insulating layer covering the pair of inner core wires by extrusion molding, each of the pair of inner core wires includes an inner conductor and an inner insulating layer covering the inner conductor, and the sheath wraps the insulating layer in a spiral winding way.

Compared to prior art, in the present invention, the two inner core wires are in contact with each other, the insulating layer is extruded and molded around the two core wires, making the core wires into an integral structure, the position of the two inner core wires is not easy to change during subsequent processing, and the cable structure is more stable. Moreover, the sheath is wrapped outside the insulating layer, making the cable easier to bend, and the distance between the two inner conductors is smaller, thereby reducing the outer diameter of the overall cable.

### BRIEF DESCRIPTION OF THE DRAWING

FIG. 1 is a cross-sectional view of a first embodiment of a cable of the present invention;

FIG. 2 is a cross-sectional view of a second embodiment of a cable of the present invention; and

FIG. 3 is a cross-sectional view of a third embodiment of a cable of the present invention.

### DETAILED DESCRIPTION OF THE PREFERRED EMBODIMENT

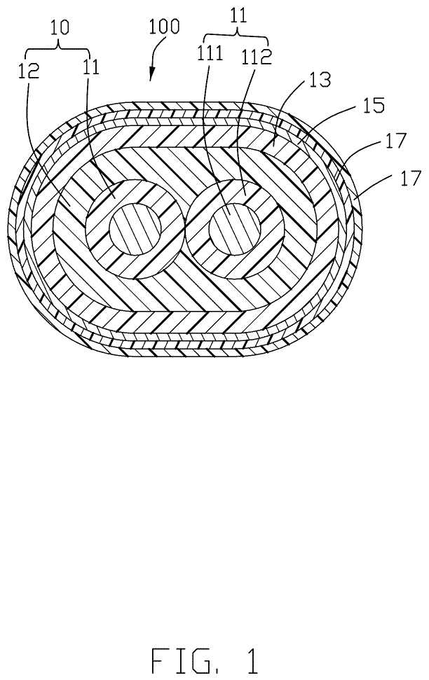

Referring to FIG. 1, the first embodiment of a cable 100 of the present invention is shown. The cable 100 includes a core wires 10, a sheath 13 covering the core wire 10, a shielding layer 15 covers the sheath 13, an outer insulating layer 17 covers the shielding layer 15. The core wire 10 includes a pair of inner core wires 11 and an insulating layer 12 covering the pair of inner core wires 11 by extrusion molding. The sheath 13 is wrapped around the insulation layer 12 of the pair of inner core wires in a spiral winding way.

The pair of inner core wires 11 are arranged side by side longitudinally and in contact with each other. Each of the pair of inner core wires includes an inner conductor 111 and an inner insulating layer 112 covering the inner conductor 111. The inner conductor 111 is used to transmit high-speed signals. The inner insulating layer 112 of the inner core wire 11 covers the respective inner conductor 111 by extrusion molding. The pair of inner core wires 11 are made separately to facilitate size control. The surfaces of the inner insulating layers 112 of the two inner core wires 11 are in contact with each other. The inner insulating layer 112 can be one of PP (polypropylene), PE (polyethylene), foamed PP, foamed PE, PFA (Polyfluoroalkoxy), ETFE (ethylene-tetra-fluoro-ethylene), and foamed FEP (Fluorinated ethylene propylene).

The insulating layer 12 is extruded and molded to cover the two inner core wires 11 that are contact with each other, so that the distance between the two inner conductors 111 is the thickness of the two inner insulating layers 112, in this way, the relative positions of the two inner conductors 111 are fixed. There is no air gap between the insulating layer 12 and the inner core wire 11. The insulating layer 12 can be one of PP, PE, foamed PP, foamed PE, PFA, ETFE, and foamed FEP.

The dielectric constant of the material of the sheath 13 is smaller than the dielectric constant of the material of the inner insulating layer 112, and is also smaller than the dielectric constant of the material of the insulating layer 12. Specifically, the material of the sheath 13 is e-PTFE (foamed Polytetrafluoroethylene) or PTFE. e-PTFE and PTFE have smaller dielectric constants and smaller loss factors. Therefore, the overall attenuation value of the cable 100 is smaller and the electrical performance is better, which is better to the transmission of high-speed signals. However, if e-PTFE and PTFE materials are directly extruded outside the core wire, due to the limitations of the material itself, the extrusion speed will be very slow, and the extruded size will also be unstable, which will affect the stability of signal transmission. Therefore, the sheath 13 is first made into a tape, and then wrapped around the core wire 10, and the sheath 13 is wrapped to facilitate the bending of the cable.

The shielding layer 15 covers the sheath 13 in a longitudinal wrapping manner or in a spiral winding manner. The shielding layer 15 is any one of aluminum-coated PET, aluminum-coated PP, aluminum-coated PI (Polyimide), copper-coated PI, copper-coated PET, pure copper tape, graphene metal tape, and graphene double-layer metal tape.

The outer insulating layer 17 is made of PET material or PI material. The outer insulating layer 17 can be provided as one or more layers. Specifically, in this embodiment, the outer insulating layer 17 is provided with two layers. The outer insulating layer 17 is wrapped around the shielding layer 15.

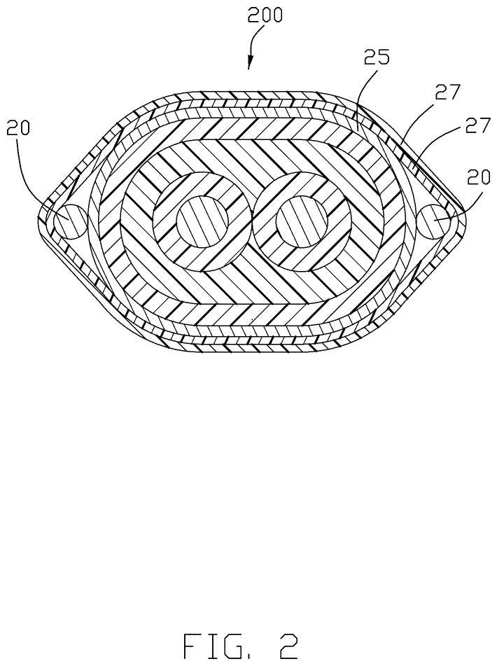

FIG. 2 shows the second embodiment of a cable 200 of the present invention. Compared with the first embodiment, in this embodiment, the cable further includes a pair of ground wires 20 disposed between the shielding layer 25 and the outer insulating layer 27. The pair of ground wires 20 are respectively located on the left and right sides of the shielding layer 25. In other embodiments, only one ground wire 20 may be provided.

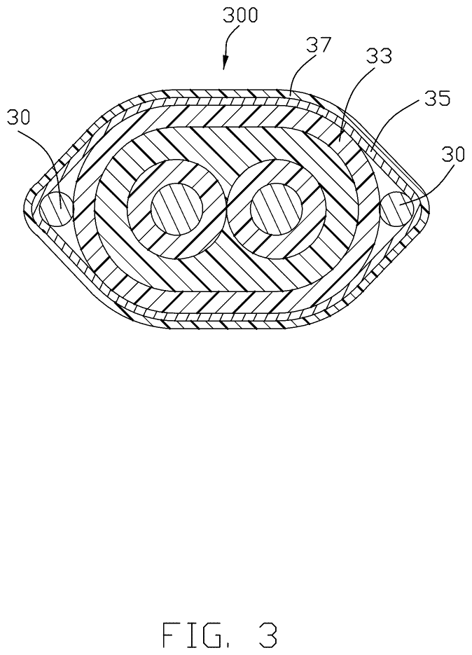

FIG. 3 shows the third embodiment of a cable 300 of the present invention. Compared with the second embodiment, in this embodiment, a pair of ground wires 30 is provided between the sheath 33 and the shielding layer 35. In this embodiment, the outer insulating layer 37 is provided as one layer. In other embodiments, only one ground wire 30 may be provided.

The two inner core wires 11 of the present invention are in contact with each other, so that the two inner conductors 111 are separated by the thickness of the two inner insulating layers 112, in this way the relative position of the two inner conductors 111 is certain, and then the insulating layer 12 is extruded and molded outside the two inner core wires, so that the cable becomes an integral structure. The position of the two inner core wires 11 is not easily changed during subsequent processing, so the cable structure is more stable. The distance between the two inner conductors 111 in this invention is smaller than the distance in the prior art where the inner insulating layer is extruded outside the two inner conductors at one time. In this way, the overall outer diameter of the cable is smaller while ensuring the overall impedance matching. In addition, the sheath 33 with a smaller dielectric constant is wrapped around the insulating layer 12, which not only has better electrical performance, but also facilitates the bending of the cable.

1. A cable comprising:
a core wire;
a sheath covering the core wire;
a shielding layer covering the sheath; and
an outer insulating layer covering the shielding layer; wherein
the core wire includes a pair of inner core wires and an insulating layer covering the pair of inner core wires by extrusion molding, each of the pair of inner core wires includes an inner conductor and an inner insulating layer covering the inner conductor, and the sheath wraps the insulating layer in a spiral winding way.

2. The cable as claimed in claim 1, wherein the pair of inner core wires are arranged side by side longitudinally and in contact with each other.

3. The cable as claimed in claim 1, wherein the inner insulating layer covers the corresponding inner conductor by extrusion molding.

4. The cable as claimed in claim 1, wherein the inner insulating layer is selected from the group consisting of PP, PE, foamed PP, foamed PE, PFA, ETFE, and foamed FEP.

5. The cable as claimed in claim 1, wherein the insulating layer is selected from the group consisting of PP, PE, foamed PP, foamed PE, PFA, ETFE, and foamed FEP.

6. The cable as claimed in claim 1, wherein the material of the sheath is e-PTFE or PTFE.

7. The cable as claimed in claim 1, wherein the shielding layer is selected from the group consisting of aluminum-coated PET, aluminum-coated PP, aluminum-coated PI, copper-coated PI, copper-coated PET, copper tape, graphene metal tape, and graphene double-layer metal tape.

8. The cable as claimed in claim 1, further comprising at least one ground wire arranged between the shielding layer and the outer insulating layer.

9. The cable as claimed in claim 1, further comprising at least one ground wire arranged between the sheath and the shielding layer.

10. The cable as claimed in claim 1, wherein the material of the outer insulating layer is PET or PI.
